(19) United States
(12) Patent Application Publication
(10) Pub. No.: US 2026/0364828 A1
(43) Pub. Date: Nov. 19, 2026

(54) Mammoth Empire Knife and Glove System

(71) Applicant: Richard S. Anderson, Geneva, AL (US)

(72) Inventor: Richard S. Anderson, Geneva, AL (US)

(21) Appl. No.: 19/211,077

(22) Filed: May 16, 2025

(51) Int. Cl. B26B 11/00; B26B 29/02

(52) U.S. Cl. CPC B26B 11/008; B26B 29/025

(57) ABSTRACT

An embodiment of the present invention is a modular smart knife system comprising: a fixed or assisted-opening blade; a detachable digital screen module configured to display environmental data; integrated USB-C charging port and rechargeable battery; a tactical lighting system; an embedded stun-gun contact module; a smart locking sheath with biometric authentication; and a satellite emergency beacon integrated into the sheath or hilt, wherein all components are interconnected and operable as a unified survival and defense tool.

### FIELD OF INVENTION

The present invention relates to knives and knife handles.

### SUMMARY OF INVENTION

The present invention provides a modular, tech-integrated knife platform that allows customers to select custom hardware and power features during purchase. The core design includes a rechargeable battery integrated into the knife handle, enabling advanced digital and utility functions while maintaining structural integrity for daily or survival use.

### BRIEF DESCRIPTION OF THE DRAWINGS

FIG. 1 illustrates a Smart Knife Exploded View.

FIG. 2 illustrates a Vault Screen Module (Zoom-In View).

FIG. 3 illustrates a Combat Loadout (Knife+Glove+Docking System).

FIG. 4 illustrates a Tactical Glove Module Breakdown.

FIG. 5 illustrates an EMP Shielding System Diagram.

FIG. 6 illustrates a Satellite Beacon & Emergency Communication Diagram.

### DETAILED DESCRIPTION

The Core Patent-Worthy Innovations:

1. Power-Enabled Knife Handle Platform
Internal housing for a rechargeable power cell
Multiple charging methods:
USB-C Port
Integrated Solar Panel (optional)
Wireless Charging Pad (optional)
Power source enables all smart features below

2. Integrated Digital Screen Interface
Small LCD or LED screen flush-mounted into handle scale or spine
Displays:
   Battery %
   Compass
   Temperature
   Clock/Date
   Device pairing or activation modes (if applicable)

3. Stun Gun Integration (Optional Add-On)
Dual electrode points either on:
   Knife guard
   Butt cap
   Side of handle
Activates via safety grip sensor+thumb switch
Non-lethal, battery-powered stun burst designed for personal defense or survival

4. LED/UV Lighting Modules
Handle or spine-embedded lights
Selectable color modes:
   White (utility)
   Red (stealth/night)
   UV/Blacklight (visual tracking, presentation)
Touch button or screen-controlled

5. Multi-Tier Configuration Options for End-Users
Customers can select hardware options pre-build (via configurator or form)
Example features to choose from:
   Digital screen
   Solar charge cell
   LED/UV light modules
   Stun module
   Tracking chip
   Emergency beacon
   Hidden tool storage (under scale)
   Laser pointer
      Bluetooth pairing capability (for device sync, updates, or location tracking)

Design Distinction:
All modules are compact, rugged, and designed to retain full knife balance, safety, and grip

performance
Aesthetics match survival/tactical or collector-grade presentation
   Blades available in traditional steels (Damascus, carbon) with customized scale materials

Use Cases:
Survival/Field Utility
Tactical/Military
Collector/EDC
Emergency Preparedness
Recreational (camping, off-grid, etc.)
Promotional/Display (Wild Edition)

Concept Overview: Modular Smart Knife System

This smart knife system is built as a modular, user-configurable platform that merges traditional blade functionality with modern digital and survival tech. A key innovation lies in the knife's internal power and control module, which powers selected user features ranging from lighting and tracking to defense and communication.

The knife remains ergonomic, balanced, and rugged despite its embedded technologies, allowing for both field use and urban carry. The handle scale or spine serves as a housing for essential tech modules, including the screen interface, LEDs, and charging ports, while the blade remains customizable in material and shape.

Conceptually, the smart knife is positioned to serve both hardcore survivalists and next-gen collectors who demand a blend of utility, innovation, and style.

Edge Material Innovation: Near-Perpetual Sharpness

A key innovation opportunity for the Next-Gen Modular Smart Knife is the use of ultra-durable edge materials that retain sharpness for extended periods, potentially eliminating the need for frequent sharpening. Material candidates include:
Tungsten Carbide: Extremely hard, long-lasting edge, ideal for slicing applications.
Maxamet or CPM-S110V Super Steels: Powder metallurgy alloys that offer exceptional wear resistance and edge retention.
Ceramic (Zirconium Dioxide): Razor-sharp and corrosion-resistant; extremely hard, though brittle under stress.
DLC (Diamond-Like Carbon) Coating: Used to enhance edge durability and surface hardness while minimizing friction.

These materials, when properly heat-treated or bonded, can give the knife a near-permanent edge for typical EDC or field use.

Waterproof Technology Integration: Field-Ready Sealing System

The Next-Gen Modular Smart Knife is engineered for full waterproof performance to ensure
durability in extreme outdoor environments. The integrated waterproofing system includes:
   IP67/IP68-rated housing for full resistance to dust and water ingress
   Gasketed internal compartments with silicone or rubber o-ring seals
Rubberized charging port covers that snap-lock or twist-seal into place
Internal electronics coated in hydrophobic nanotechnology film to resist corrosion and shorts
Designed for use in rain, snow, submersion, mud, and high-humidity survival conditions

These features make the knife reliable and secure even when exposed to the harshest field environments.

Integrated Rechargeable Battery Core

The heart of the smart knife's technological system is a compact, high-performance rechargeable battery integrated within the handle. This power unit enables all digital functions without compromising the knife's balance or structural integrity.

Key Battery Specifications:
Type: Lithium-Ion (Li-ion) Prismatic Flat Cell
Voltage: 3.7V
Capacity: 500 mAh to 1000 mAh (depending on module configuration)
Size: Compact thin format, optimized to fit inside handle scale cavity
Charging Methods: USB-C, integrated solar panel, or optional wireless pad
Smart Features: Integrated thermal protection, overcharge cutoff, voltage regulation circuit

Sources for high-quality battery cells include manufacturers such as Panasonic, Samsung, LG, and specialty suppliers such as Tenergy, Amprius, or EEMB.

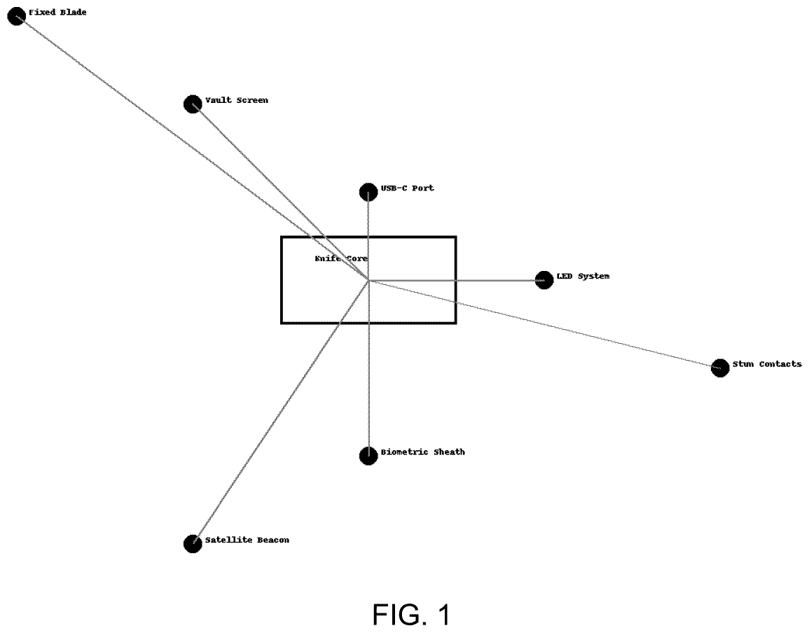

FIG. 1 illustrates a Smart Knife Exploded View.

The diagram presents an exploded view of the Mammoth Empire Smart Knife System. It highlights the following key modular components that define the system's multifunctional design.

Fixed Blade

Vault Screen (detachable digital display module)

USB-C Charging Port

Tactical LED Lighting System

Stun Gun Contacts

Biometric Locking Sheath

Satellite Emergency Beacon (off-grid SOS feature)

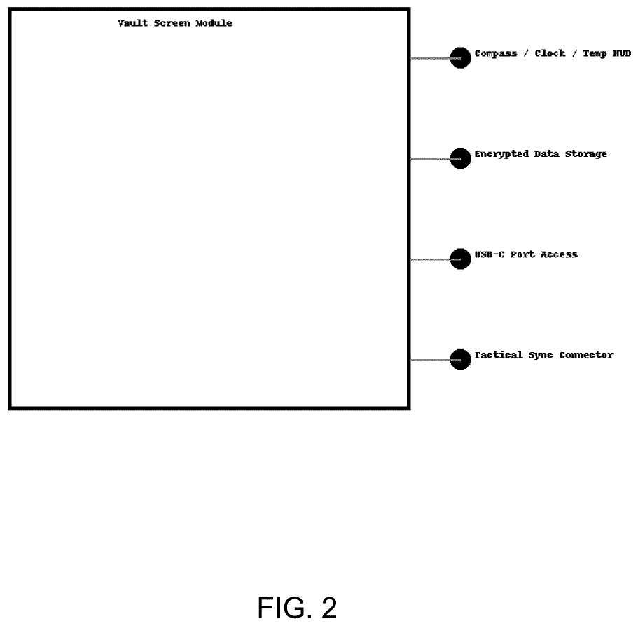

FIG. 2 illustrates a Vault Screen Module (Zoom-In View).

This diagram presents a close-up view of the detachable Vault Screen Module within the Mammoth Empire Smart Knife System. The module integrates critical digital and survival functions and serves as a core interface for the user.

Compass/Clock/Temperature Heads-Up Display (HUD)

Encrypted Digital Data Storage (Personal Files, Credentials, etc.)

USB-C Charging and Data Transfer Port

Tactical Sync Connector (Interface with Knife, Glove, or Docking Station)

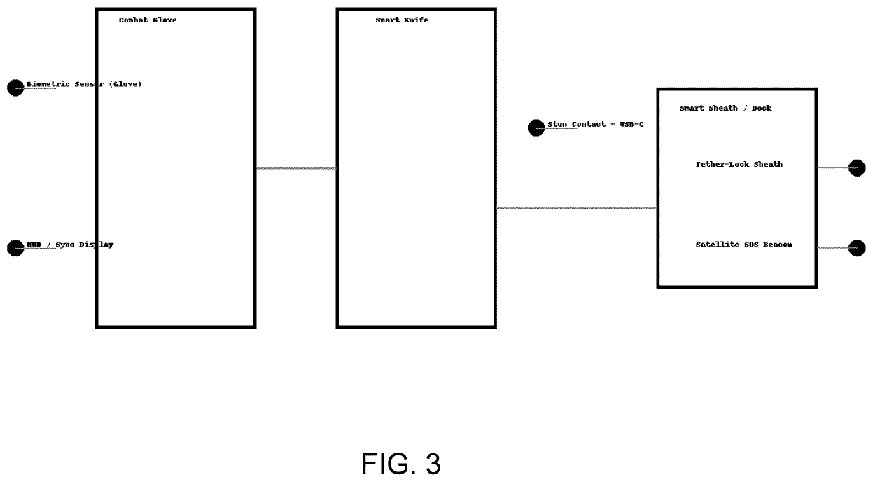

FIG. 3 illustrates a Combat Loadout (Knife+Glove+Docking System).

This diagram presents a tactical configuration of the Mammoth Empire system, showcasing how the smart knife, biometric glove, and docking sheath interconnect for complete field-ready functionality. Each module is designed to operate independently or as part of a synchronized combat system.

Biometric Sensor on Combat Glove (Fingerprint/Facial Recognition Access)

HUD/Sync Display on Glove for On-Hand Data and System Feedback

Knife Module with Stun Contact and USB-C Power Interface

Smart Sheath with Tether-Lock for Theft Protection and Secure Carry

Integrated Satellite SOS Beacon for Off-Grid Emergency Signaling

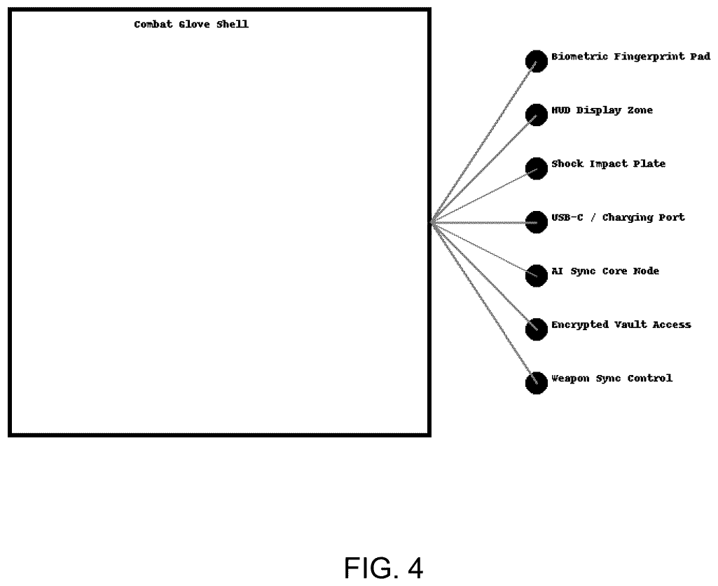

FIG. 4 illustrates a Tactical Glove Module Breakdown.

The following diagram provides a detailed breakdown of the Mammoth Empire Tactical Glove Module. This glove operates as a standalone combat asset and as a synced extension of the smart knife system. Each integrated feature enhances survivability, control, and communication.

Biometric Fingerprint Pad—Secures glove activation and knife syncing

HUD Display Zone—Projects vital stats from knife or satellite feed

Shock Impact Plate—Delivers defense-grade electric pulse in emergencies

USB-C/Charging Port—Charges glove or powers external device

AI Sync Core Node—Central processor for command recognition

Encrypted Vault Access—Secure storage for personal data or mission files

Weapon Sync Control—Controls and locks paired smart knife functionality

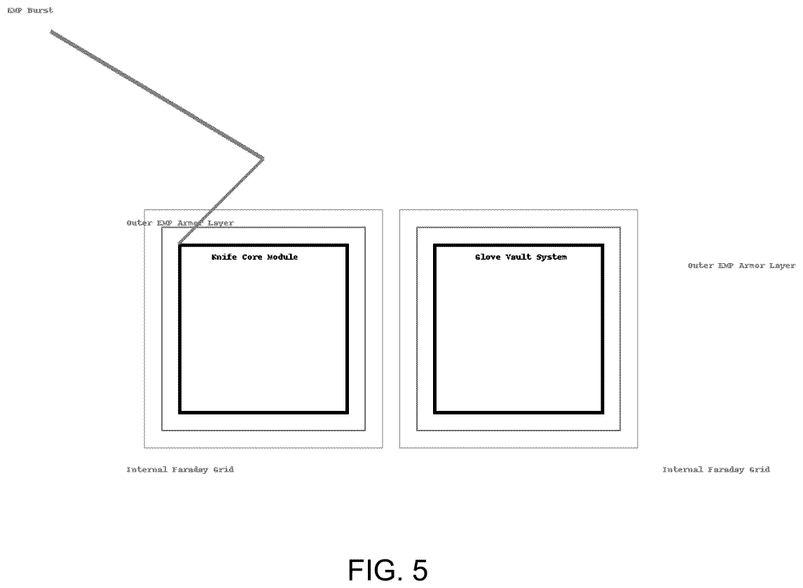

FIG. 5 illustrates an EMP Shielding System Diagram.

This diagram illustrates the EMP shielding architecture of the Mammoth Empire smart knife and glove systems. Designed for battlefield reliability, the system is protected by both external and internal EMP defense layers. The goal: full operational integrity during electromagnetic pulse events, whether natural or hostile.

Outer EMP Armor Layer—Conductive carbon or alloy shell that redirects high-frequency energy away from internal components.

Internal Faraday Grid—Fine mesh internal barrier that neutralizes pulse interference and voltage spikes.

Redundant Isolation Zones—Separates sensitive microelectronics to prevent cascade failure during EMP events.

Shielded Ports & Cables—All connections are wrapped in grounded shielding to prevent data or power surge intrusion.

Operational Lockdown Mode—Auto-engages when EMP is detected to freeze systems and preserve memory integrity.

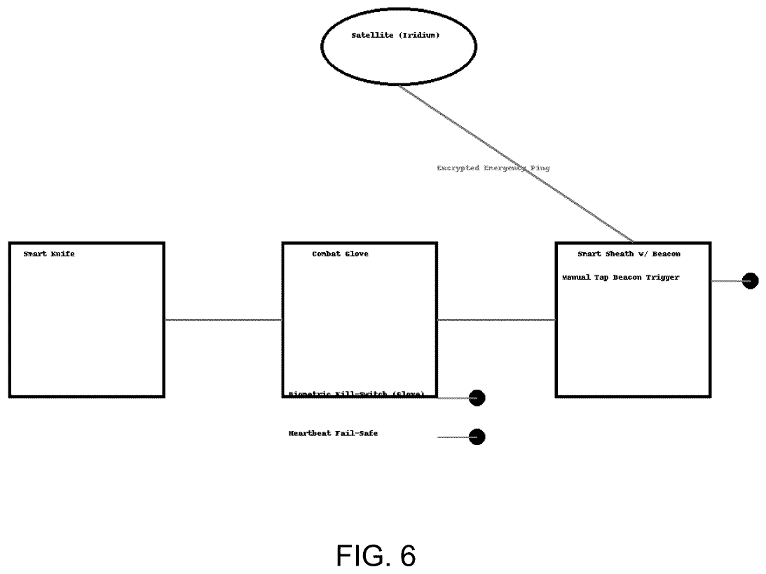

FIG. 6 illustrates a Satellite Beacon & Emergency Communication Diagram.

This diagram showcases the off-grid communication capabilities of the Mammoth Empire system. The smart knife, combat glove, and sheath are all connected to a tactical beacon capable of transmitting encrypted emergency alerts via satellite (Iridium network or similar). This function ensures survivability even in zero-signal, high-risk environments.

Manual Tap Beacon Trigger—Allows user to manually send a distress signal from the sheath.

Biometric Kill-Switch (Glove)—Triggers emergency transmission when unauthorized use or user loss is detected.

Heartbeat Fail-Safe—If vital signs drop, the glove triggers a satellite ping containing user ID and last known coordinates.

Encrypted Emergency Ping—Signals are routed via satellite and protected through internal encryption systems.

Device Chain of Command—Knife and glove feed beacon; sheath transmits. Beacon acts as off-grid uplink module.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A modular smart knife system comprising:
a fixed or assisted-opening blade;
a detachable digital screen module configured to display environmental data;
integrated USB-C charging port and rechargeable battery;
a tactical lighting system;
an embedded stun-gun contact module;
a smart locking sheath with biometric authentication; and
a satellite emergency beacon integrated into the sheath or hilt,
wherein all components are interconnected and operable as a unified survival and defense tool.

2. The system of claim 1, wherein the digital screen module displays a compass, clock, and temperature data.

3. The system of claim 1, wherein the sheath lock is tetherable and releases only via fingerprint or facial recognition.

4. The system of claim 1, wherein the knife includes encrypted data storage accessible through the detachable screen module.
